(19) United States
(12) Patent Application Publication
(10) Pub. No.: US 2026/0005518 A1
(43) Pub. Date: Jan. 1, 2026

(54) PHOTOVOLTAIC INVERTER AND METHOD FOR CONTROLLING PHOTOVOLTAIC INVERTER

(71) Applicant: Sungrow Power Supply Co., Ltd., Hefei (CN)

(72) Inventors: Jingjing Wang, Hefei (CN); Cheng Liang, Hefei (CN); Nian'an Pan, Hefei (CN); Yuandong Qian, Hefei (CN); Yang Zhou, Hefei (CN); Qingpeng Wang, Hefei (CN)

(73) Assignee: Sungrow Power Supply Co., Ltd., Hefei (CN)

(21) Appl. No.: 19/028,216

(22) Filed: Jan. 17, 2025

(30) Foreign Application Priority Data
Jun. 27, 2024 (CN) 202410852412.1

(51) Int. Cl. H02J 3/38; H02H 7/20; H02J 3/24

(52) U.S. Cl. CPC H02J 3/38; H02J 3/24; H02H 7/20; H02J 2300/26

(57) ABSTRACT

A photovoltaic inverter and a method for controlling the photovoltaic inverter are provided. The photovoltaic inverter includes a main circuit and a controller. A direct-current side of the main circuit is configured to connect a photovoltaic array, and an alternating-current side of the main circuit is configured to connect a power grid and/or a load. The controller controls the main circuit to operate; and in response to an occurrence of a power oscillation in the main circuit, regulates a direct-current voltage of the main circuit to an open-circuit voltage or a voltage close to the open-circuit voltage and then controls the main circuit to perform a global MPPT search based on the regulated voltage.

The present application claims priority to China Patent Application No. 202410852412.1, titled “PHOTOVOLTAIC INVERTER AND METHOD FOR CONTROLLING PHOTOVOLTAIC INVERTER”, filed on Jun. 27, 2024 with the China National Intellectual Property Administration, which is incorporated herein by reference in its entirety.

### FIELD

The present disclosure relates to the technical field of inverter control, and in particular to a photovoltaic inverter and a method for controlling the photovoltaic inverter.

### BACKGROUND

Changes in external environmental factors, such as changes in light intensity or temperature, affect a maximum power point of a photovoltaic array. If the changes occur slowly, a photovoltaic inverter tracks maximum power points under different environmental conditions by a maximum power point tracking (MPPT) strategy in the conventional technology.

However, in practice, the changes in external environmental factors do not occur slowly enough, the photovoltaic inverter fails to operate at the maximum power point of the photovoltaic array in a real time manner according to the conventional technology. If a direct-current voltage of the photovoltaic inverter enters an unstable interval of a characteristic curve of the photovoltaic array, easily resulting in a power oscillation, thus affecting the grid-connected power quality.

### SUMMARY

In view of the above problems, a photovoltaic inverter and a method for controlling the photovoltaic inverter are provided according to the present disclosure, to suppress a power oscillation and avoid the impact on grid-connected power quality.

In a first aspect, a photovoltaic inverter is provided according to the present disclosure, and includes a main circuit and a controller.

A direct-current side of the main circuit is configured to connect a photovoltaic array.

An alternating-current side of the main circuit is configured to connect a power grid and/or a load.

The controller is configured to control the main circuit to operate; and in response to an occurrence of a power oscillation in the main circuit, regulate a direct-current voltage of the main circuit to a voltage with a difference from an open-circuit voltage of the photovoltaic array less than a preset difference and control the main circuit to perform a global maximum power point tracking (MPPT) search based on the regulated voltage.

In second aspect, a method for controlling a photovoltaic inverter is provided according to the present disclosure, and includes: in response to an occurrence of a power oscillation in a main circuit of the photovoltaic inverter, regulating a direct-current voltage of the main circuit to a voltage with a difference from an open-circuit voltage of a photovoltaic array connected to the main circuit less than a preset difference; and controlling the main circuit to perform a global maximum power point tracking (MPPT) search based on the regulated voltage.

### BRIEF DESCRIPTION OF THE DRAWINGS

The above and other features, advantages and aspects of the embodiments of the present disclosure are more apparent in conjunction with the drawings and with reference to the following embodiments. The same or similar reference numerals throughout the drawings represent the same or similar elements. It should be understood that the drawings are schematic, the components and elements may not be drawn to scale.

FIG. 1 is a schematic diagram of characteristic curves of a photovoltaic array under different light conditions according to an embodiment of the present disclosure;

FIG. 2 is a schematic diagram of characteristic curves of a photovoltaic array under different temperature conditions according to an embodiment of the present disclosure;

FIG. 3 is a schematic diagram of P-V curves under an oversizing condition of photovoltaic modules according to an embodiment of the present disclosure;

FIG. 4 is a schematic diagram of P-V curves before and after shading removal according to an embodiment of the present disclosure;

FIG. 5 is a schematic diagram of waveforms of a direct-current voltage and a three-phase grid current in a case that a power oscillation occurs in an inverter according to an embodiment of the present disclosure;

FIG. 6 is a schematic structural diagram of an inverter according to an embodiment of the present disclosure;

FIG. 7 is a schematic structural diagram of a central inverter according to an embodiment of the present disclosure;

FIG. 8 is a schematic structural diagram of a string inverter according to an embodiment of the present disclosure;

FIG. 9 is a schematic diagram of suppression effect of a power oscillation according to an embodiment of the present disclosure;

FIG. 10 is a flow chart of a method for controlling a photovoltaic inverter according to an embodiment of the present disclosure;

FIG. 11 is a flow chart of a method for controlling a photovoltaic inverter according to another embodiment of the present disclosure;

FIG. 12 is a flow chart of a method for controlling a photovoltaic inverter according to another embodiment of the present disclosure; and

FIG. 13 is a flow chart of a method for controlling a photovoltaic inverter according to another embodiment of the present disclosure.

### DETAILED DESCRIPTION

The embodiments of the present disclosure are illustrated as follows with reference to the drawings in the embodiments of the present disclosure. The terms in the embodiments of the present disclosure are only for the purpose of explaining embodiments of the present disclosure, rather than limiting the present disclosure.

The embodiments of the present disclosure are illustrated in conjunction with the drawings. It is apparent that the described embodiments are only some embodiments of the present disclosure, rather than all embodiments. Based on the embodiments of the present disclosure, all other embodiments obtained by those skilled in the art without any creative effort fall within the protection scope of the present disclosure. Those skilled in the art may understand that, with the development of technology and the emergence of new scenarios, the technical solution according to the embodiments of the present disclosure is also applies to similar technical problems.

In the specification, the claims and the drawings of the present disclosure, terms such as “first” and “second” are merely for distinguishing similar objects rather than describing a specific order or sequence. It should be understood that the terms used in this way may be interchanged in appropriate cases, and the terms are used to distinguish objects with the same attributes in the embodiments of the present disclosure in describing the objects. In addition, the terms “include” and “comprise” and any variations thereof are intended to be non-exclusive, so that a process, method, system, product or device including a series of units includes not only the units but also other units that are not enumerated, or also units inherent in the process, method, product or device.

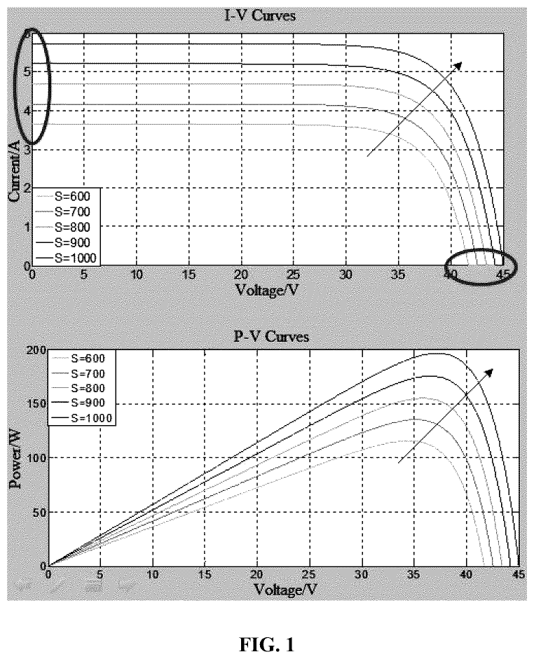

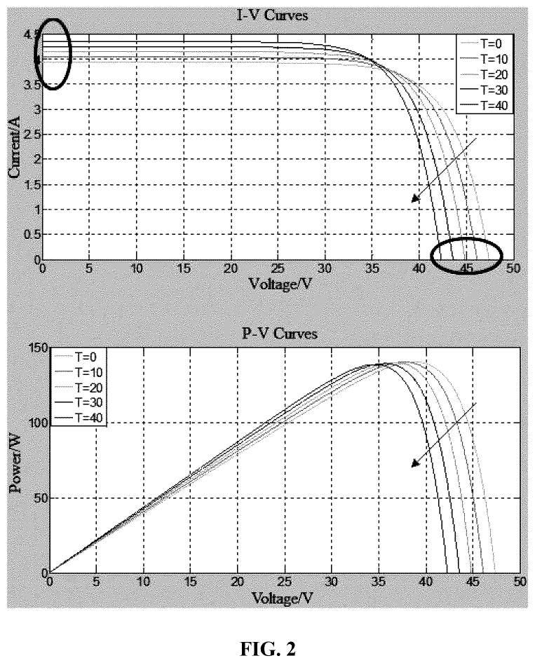

Changes in the external environmental factors, such as light intensity or temperature of a photovoltaic array, affect a maximum power point of the photovoltaic array, as shown in FIG. 1 and FIG. 2. FIG. 1 illustrates characteristic curves of a photovoltaic array under different light conditions. FIG. 2 illustrates characteristic curves of a photovoltaic array under different temperature conditions. As shown in FIG. 1 and FIG. 2, upper half regions illustrate current-voltage (I-V) curves, and lower half regions illustrate power-voltage (P-V) curves. FIG. 1 exemplarily illustrates situations at light intensities of 600 lux, 700 lux, 800 lux, 900 lux, and 1000 lux, with an arrow indicating an increase of light intensity. FIG. 2 exemplarily illustrates situations at temperatures of 0° C., 10° C., 20° C., 30° C. and 40° C., with an arrow indicating an increase of temperature.

If the light intensity and the temperature change slowly, a step size of a local MPPT search in a conventional MPPT strategy meets search requirements, and thus a photovoltaic inverter can track maximum power points under different conditions by using the local MPPT search. Moreover, a photovoltaic power station is generally located in flat and open areas, especially a photovoltaic power station where a central inverter is located in. Therefore, in the conventional technology, the photovoltaic inverter usually performs a global MPPT search when starting up, and then operates in the local MPPT search throughout the day, to reduce power generation loss caused by the global MPPT search. If the global MPPT search is required again after startup, the global MPPT search is manually initiated.

However, in practice, if the external environment changes rapidly, the step size of the local MPPT search fails to meet the corresponding search requirements, thus failing to ensure that the photovoltaic inverter operates at the maximum power point of the photovoltaic array in a real time manner.

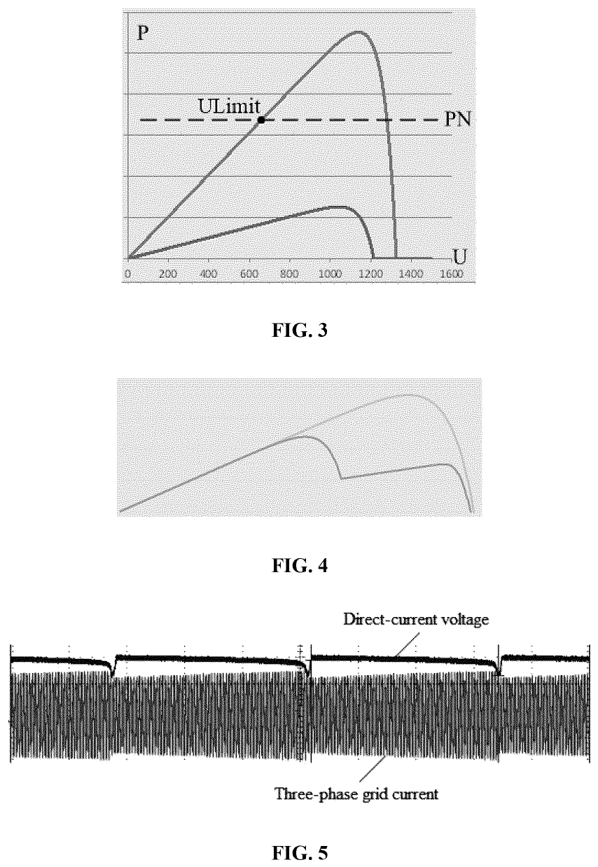

For example, in European and American regions, photovoltaic modules usually have an excessive DC/AC oversizing, in order to maximize the power generation capacity of the photovoltaic inverter. In some regions, the DC/AC oversizing reaches 1.4. That is, a photovoltaic inverter with a rated power of 500 kW is connected to a photovoltaic array with a rated power of 700 kW. Under the excessive DC/AC oversizing, when sunlight is weak in the morning, the photovoltaic inverter performs the global MPPT search to obtain an initial maximum power point at a small voltage, and then performs the local MPPT search based on the initial maximum power point at the small voltage. When sunlight is strong, the photovoltaic inverter rapidly enters a full-power operation. In this case, a power of the photovoltaic inverter is limited by a full power PN of the photovoltaic inverter due to the DC/AC oversizing, failing to obtain an actual maximum power point of the photovoltaic array, instead, a lower limit value ULimit of a MPPT voltage of the photovoltaic inverter may be obtained and the photovoltaic inverter keeps an operation of the lower limit value ULimit. When sunlight is weak in the afternoon, the photovoltaic inverter no longer operates at the full power, and the lower limit value ULimit is located on the left side of the actual maximum power point of the photovoltaic array, as shown in FIG. 3.

In addition, when shading occurs, a P-V curve may be easily formed as two peaks under shading. After the shading is removed, the MPPT voltage is located on the left side of the maximum power point, as shown in FIG. 4.

An unstable interval is located the left side of the maximum power point on the characteristic curve of the photovoltaic array. Within the interval, as a power outputted from the photovoltaic inverter increases, the power oscillation occurs in the photovoltaic inverter more easily, as shown in FIG. 5. Once a direct-current voltage of the photovoltaic inverter enters the interval and the power is large, the photovoltaic inverter is prone to power oscillation, thus inevitably affecting the grid-connected power quality of the photovoltaic inverter.

Therefore, a photovoltaic inverter is provided according to embodiments of the present disclosure, to suppress the power oscillation, thus avoiding the impact on the grid-connected power quality.

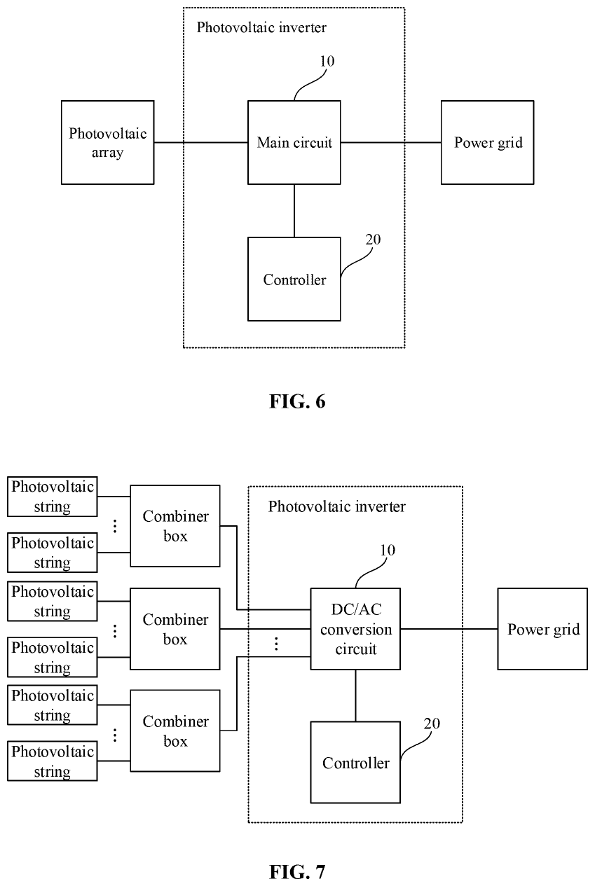

Referring to FIG. 6, the photovoltaic inverter includes a main circuit 10 and a controller 20. A direct-current side of the main circuit 10 is configured to connect a photovoltaic array. An alternating-current side of the main circuit 10 is configured to connect a power grid and/or a load.

In an embodiment, the main circuit 10 may only include a DC/AC conversion circuit, which is a structure commonly used in a central inverter. Referring to FIG. 7, the direct-current side of the main circuit 10 is connected to multiple photovoltaic strings through multiple combiner boxes corresponding to the multiple photovoltaic strings, thereby connecting the photovoltaic array formed by the multiple photovoltaic strings. Alternatively, the main circuit 10 may also include the DC/AC conversion circuit and at least one DC/DC conversion circuit connected to a direct-current side of the DC/AC conversion circuit, which is a structure commonly used in a string inverter. Referring to FIG. 8, an input side of each DC/DC conversion circuit serves as a corresponding interface of the direct-current side of the main circuit 10, to connect at least one photovoltaic string, so that the main circuit 10 is connected to the photovoltaic array formed by all photovoltaic strings.

The alternating-current side of the main circuit 10 is usually provided with a filter, a transformer, or the like. Other structures of the photovoltaic inverter are referred to the conventional technology and are not described in detail herein.

The controller 20 is configured to control the main circuit 10 to operate, and is further configured to, in response to an occurrence of the power oscillation in the main circuit 10: regulate a direct-current voltage of the main circuit 10 to a voltage with a difference from an open-circuit voltage Uoc of the photovoltaic array less than a preset difference and control the main circuit 10 to perform a global MPPT search.

In an embodiment, as shown in FIG. 7, the main circuit 10 only includes the DC/AC conversion circuit, and the direct-current voltage of the main circuit 10 is a voltage at the direct-current side of the DC/AC conversion circuit. In this case, the open-circuit voltage Uoc of the photovoltaic array is an open-circuit voltage of photovoltaic strings connected in parallel that are connected to the direct-current side of the DC/AC conversion circuit. In an embodiment, as shown in FIG. 8, the main circuit 10 includes the DC/AC conversion circuit and at least one DC/DC conversion circuit, and the direct-current voltage of the main circuit 10 includes a voltage at an input side of the at least one DC/DC conversion circuit. In this case, the direct-current voltage of the main circuit 10 is regulated to the voltage with the difference from the open-circuit voltage Uoc of the photovoltaic array less than the preset difference, that is, for each of the at least one DC/DC conversion circuit, the voltage at the input side of the DC/DC conversion circuit is regulated to the open-circuit voltage of the photovoltaic string connected to the input side of the DC/DC conversion circuit, or regulated to a voltage with a difference from the open-circuit voltage of the photovoltaic string connected to the input side of the DC/DC conversion circuit less than the preset difference.

The preset difference is determined based on actual conditions, as long as the preset difference ensures that the direct-current voltage of the main circuit 10 is close to the open-circuit voltage Uoc. All implementations fall within the scope of protection of the present disclosure.

That is, if the power oscillation occurs in the photovoltaic inverter, the controller 20 regulates the direct-current voltage of the photovoltaic inverter to the open-circuit voltage Uoc of the photovoltaic array or a voltage close to the open-circuit voltage Uoc, and performs the global MPPT search again to obtain a maximum power point of the photovoltaic array. As a result, the direct-current voltage is outside a current interval, such as the above unstable interval, in the characteristic curve of the photovoltaic array, thereby stopping the oscillation of the photovoltaic inverter.

The photovoltaic inverter according to the embodiment can suppress the power oscillation through the above principle, thus avoiding the impact on the grid-connected power quality.

On the basis of the above embodiments, a part of functions of the controller 20 in the photovoltaic inverter are described in detail in the embodiment. For example, for regulating the direct-current voltage of the main circuit 10 to the voltage with the difference from the open-circuit voltage of the photovoltaic array less than the preset difference, the controller is further configured to block a control signal for the main circuit 10, that is, perform a pulse blocking on the main circuit 10; or limit a power of the main circuit 10, where a difference between a limited power and zero is less than a preset power, that is, the power of the main circuit 10 is limited to a relatively small value.

The preset power is not limited, depending on an application scenario, as long as the preset power ensures that the power of the main circuit 10 is relatively small and close to zero. All implementations falls within the scope of protection of the present disclosure.

That is, the controller 20 regulates the direct-current voltage of the photovoltaic inverter to the open-circuit voltage Uoc or a voltage close to the Uoc by performing the pulse blocking on the main circuit 10 or limiting the power to the relatively small value, which is not limited, depending on an application scenario. All implementations falls within the scope of protection of the present disclosure.

It should be noted that, at present, once the power oscillation occurs on site, the photovoltaic inverter is manually shut down and restarted. However, the shutdown and the restarting inevitably cause a power generation loss, resulting in a contradiction to an original intention of maintaining a local MPPT search throughout one day. However, the direct-current voltage of the main circuit 10 is regulated in any one of the above manners, so that the photovoltaic inverter, without being shut down and restarted, stops the power oscillation and resumes a normal operation with minimal power generation loss.

In practice, the direct-current voltage of the main circuit 10 is regulated to the voltage with the difference from the open-circuit voltage of the photovoltaic array less than the preset difference by directly shutting down the photovoltaic inverter. In the manner, the power oscillation can be suppressed and the impact on the grid-connected power quality can be avoided, and thus the manner falls within the scope of protection of the present disclosure.

In addition, for controlling the main circuit 10 to perform the global MPPT search, the controller 20 is further configured to control the main circuit 10 to perform the global MPPT search within a preset range.

In practice, an upper limit of the preset range is the open-circuit voltage Uoc, and a lower limit of the preset range is an upper limit of a preset oscillation interval in the characteristic curve of the photovoltaic array.

The preset oscillation interval is the unstable interval mentioned above, with the upper limit that is 0.8 times of the open-circuit voltage Uoc, that is, 0.8×Uoc, which is merely an optional example and is not limited herein.

That is, once the power oscillation occurs, the controller 20 regulates the direct-current voltage of the photovoltaic inverter to the open-circuit voltage Uoc or the voltage close to the Uoc, and then performs the global MPPT search. Different from the global MPPT search performed during early morning when the photovoltaic inverter is started up, the global MPPT search in this case is performed only within the preset range of [0.8×Uoc, Uoc], so that a total search time period can be shortened, thus rapidly finding an actual maximum power point of the current photovoltaic array, further reducing the power generation loss. Moreover, an unnecessary search process on the left side of 0.8×Uoc is avoided, thereby reducing the power generation loss caused by the unnecessary search process, and preventing the direct-current voltage of the photovoltaic inverter from entering the preset oscillation interval again.

In practice, if the upper limit of the preset oscillation interval is determined as other value to replace the above 0.8×Uoc as the lower limit of the preset range, the operation principle is the same as that of the situation where 0.8×Uoc serves as the lower limit of the preset range. All implementations fall within the scope of protection of the present disclosure.

It is worth noting that, at present, once the power oscillation occurs at a photovoltaic power station on site, power oscillation of the photovoltaic inverter is detected by manually viewing background power data or acquiring an output current waveform of the photovoltaic inverter. However, the solution of the manual detection of the power oscillation relies on the choice of timing and the professionalism of personal experience, and thus is difficult to be implemented. Therefore, the problem of difficulty in oscillation detection still exists.

On the basis of the above embodiments, another photovoltaic inverter is provided according to the present disclosure, and further includes: a detection module. The detection module is configured to detect an electrical parameter of the main circuit 10 and transmit the electrical parameter to the controller 20.

The electrical parameter includes a direct-current voltage, a direct-current current, an alternating-current voltage, an alternating-current current, or the like. That is, the detection module includes a direct-current voltage sensor, a direct-current current sensor, an alternating-current voltage sensor, an alternating-current current sensor, or the like. In the photovoltaic inverter connected to a three-phase power grid, the alternating-current voltage sensor is configured to sample a three-phase alternating-current voltage, and the alternating-current current sensor is configured to sample a three-phase alternating-current current. As shown in FIG. 7, the main circuit 10 only includes the DC/AC conversion circuit, and the direct-current voltage sensor and the direct-current current sensor may be both arranged on the direct-current side of the DC/AC conversion circuit. As shown in FIG. 8, the main circuit 10 includes the DC/AC conversion circuit and at least one DC/DC conversion circuit, and the direct-current voltage sensor and the direct-current current sensor may be both arranged on an input side of each DC/DC conversion circuit. The sensors may be arranged at other positions in the conventional technology, depending on the application scenario. All implementations fall within the scope of protection of the present disclosure.

In this case, the controller 20 is further configured to determine whether the power oscillation occurs in the main circuit 10 based on the electrical parameter.

In practice, for determining whether the power oscillation occurs in the main circuit 10, the controller 20 is further configured to: detect whether a low-frequency resonant component exists in at least one of the direct-current voltage, the direct-current current and the alternating-current current in the electrical parameter; and determine that the power oscillation occurs in the main circuit 10, in response to the low-frequency resonant component being detected in the at least one of the direct-current voltage, the direct-current current and the alternating-current current in the electrical parameter.

During the grid-connected operation of the photovoltaic inverter, the detection module samples the direct-current voltage, the direct-current current, a three-phase grid voltage (i.e., the alternating-current voltage) and a three-phase grid-connected current (i.e., the alternating-current current) in a real time manner and outputs the direct-current voltage, the direct-current current, the three-phase grid voltage and the three-phase grid-connected current to the controller 20. If the controller 20 detects that the low-frequency resonant component exists in at least one of the direct-current voltage, the direct-current current and the three-phase grid voltage, the controller 20 determines that the power oscillation occurs in the photovoltaic inverter.

In practice, the controller 20 may only detect a direct-current component, such as one or both of the direct-current voltage and the direct-current current. If the low-frequency resonant component exists in at least one of detected objects, the controller 20 determines that the power oscillation occurs. Alternatively, the controller 20 may detect whether the low-frequency resonant component exists in the direct-current voltage, the direct-current current and the alternating-current current, respectively. If the low-frequency resonant component exists in at least one of the direct-current voltage, the direct-current current and the alternating-current current, the controller 20 determines that the power oscillation occurs. Alternatively, the controller 20 may only detect whether the low-frequency resonant component exists in the three-phase grid-connected current. If the low-frequency resonant component exists in the three-phase grid-connected current, the controller 20 determines that the power oscillation occurs. The detected object depends on the application scenario. All implementations fall within the scope of protection of the present disclosure.

Through the above process, it can be proactively determined that the power oscillation occurs in the photovoltaic inverter, thus suppressing the power oscillation based on the principle described in the above embodiment.

It should be noted that, in practice, the low-frequency resonant component refers to a harmonic wave with a frequency lower than a frequency of the grid voltage. If the low-frequency resonant component is detected, it indicates that the harmonic wave is detected in the electrical parameter. The harmonic wave may be caused by a resonance generated in a process of controlling the operation of the main circuit 10. Therefore, in a case that the low-frequency resonant component is detected, the resonance generated in the control causing the harmonic wave is further be to be excluded. That is, upon determining that the power oscillation occurs in the main circuit 10 through the above process, the controller 20 is further configured to regulate the power of the main circuit 10 to be less than a lower limit of a power oscillation range; and determine whether the power oscillation occurs in the main circuit 10 again. Upon determining that no power oscillation occurs in the main circuit 10 after regulating the power of the main circuit to be less than the lower limit of the power oscillation range, the resonance generated in the control causing the harmonic wave is excluded, and the controller 20 regulates the direct-current voltage of the main circuit 10 to the voltage with the difference from the open-circuit voltage of the photovoltaic array less than the preset difference and control the main circuit 10 to perform the global MPPT search.

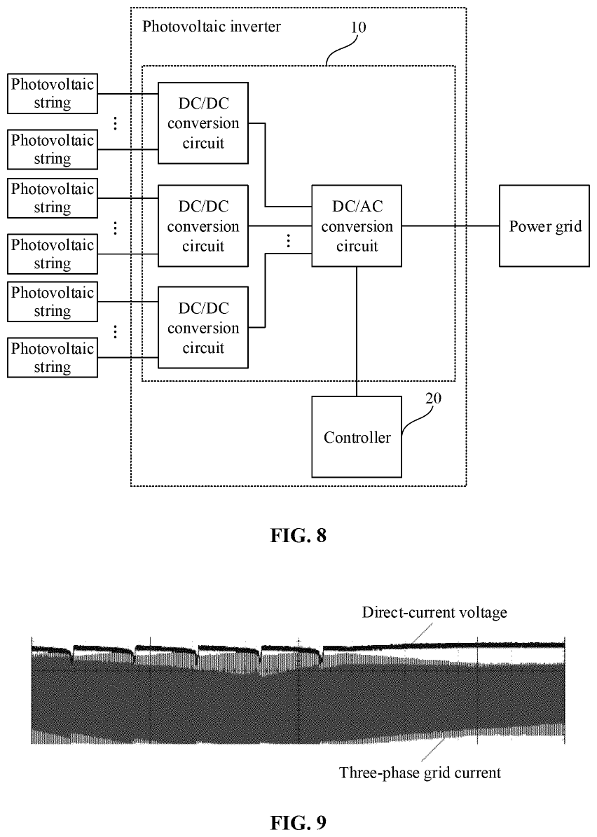

The principle includes as follows. Considering that the resonance may be generated in the process of controlling the main circuit 10 of the photovoltaic inverter, and the power oscillation caused by the resonance fails to be eliminated by reducing the power of the main circuit 10, while the power oscillation caused by the direct-current voltage entering the unstable interval can be eliminated by reducing the power of the main circuit 10 to cause the direct-current voltage to be outside the unstable interval, as shown in FIG. 9. Therefore, in response to the low-frequency resonant component being detected in the electrical parameter, the controller 20 first determines the power oscillation range of the main circuit 10 as [P1, P2], and limits the power of the main circuit 10 to P3, where P3<P1; and determines again whether the power oscillation occurs in the main circuit 10, that is, detects the electrical parameter in this case again, such as the direct-current voltage and the three-phase grid-connected current; and determines whether the low-frequency resonant component exists in the electrical parameter. If no low-frequency resonant component is detected and the power outputted by the photovoltaic inverter is P3, it is determined that the power oscillation in the photovoltaic inverter is caused by the direct-current voltage entering the unstable interval, and the above-mentioned operation for suppressing the power oscillation is performed. If the low-frequency resonant component is detected, it is determined that the occurrence of the power oscillation is caused by the resonance generated in the control, rather than being caused by the direct-current voltage entering the unstable interval, in this case, the above-mentioned operation for suppressing the power oscillation is not performed.

Further, on this basis, the controller 20 may also retest the exclusion of the resonance generated in the control. That is, after regulating the power of the main circuit 10 to be less than the lower limit P1 of the power oscillation range by limiting the power and determining that no power oscillation occurs in the main circuit 10 after regulating the power of the main circuit to be less than the lower limit of the power oscillation range, the controller 20 is further configured to release the limit on the power of the main circuit 10, to restore the power of the main circuit 10 to an original value; and determine again whether the power oscillation occurs in the main circuit 10. In this case, it is determined that the power oscillation occurs in the main circuit 10 after releasing the limit on the power of the main circuit, it is determined that the direct-current voltage enters the unstable interval again, thus determining that the original power oscillation is caused by the direct-current voltage entering the unstable interval, and the operation for suppressing the power oscillation is performed. It should be noted that no power oscillation occurs after the limit on the power of the main circuit 10 is released, which may be resulted from that the direct-current voltage failing to enter the unstable interval again is caused by the power reduction due to changes in an external environment. Therefore, whether to perform the above retest operation is determined according to a current external environment, depending on the actual application scenario. All implementations falls within the scope of protection of the present disclosure.

Through the above process in the embodiment, it can be proactively determined that the occurrence of the power oscillation in the photovoltaic inverter is caused by the direct-current voltage entering the unstable interval, and thus the direct-current voltage is controlled to be outside the unstable interval based on the above principle, thereby suppressing the power oscillation.

A method for controlling a photovoltaic inverter is further provided according to another embodiment of the present disclosure. The structure of the photovoltaic inverter is referred to the above embodiments and is not described in detail herein.

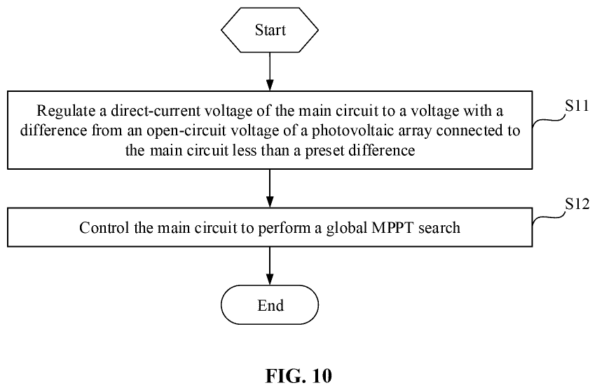

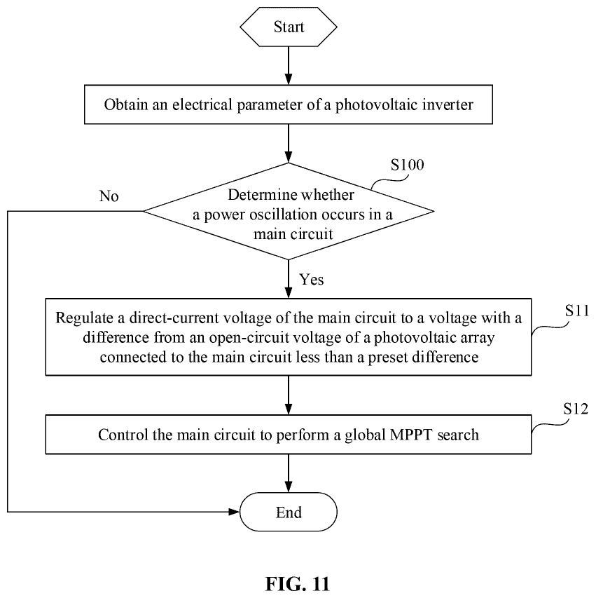

Referring to FIG. 10, the method for controlling the photovoltaic inverter includes the following steps S11 and S12, in response to an occurrence of a power oscillation in a main circuit of the photovoltaic inverter.

In step S11, a direct-current voltage of the main circuit is regulated to a voltage with a difference from an open-circuit voltage of a photovoltaic array connected to the main circuit less than a preset difference.

That is, the direct-current voltage of the main circuit is regulated to the open-circuit voltage or a voltage close to the open-circuit voltage. This process includes blocking a control signal for the main circuit; limiting a power of the main circuit, where a difference between a limited power of the main circuit and zero is less than a preset power; or shutting down the photovoltaic inverter. The principle is referred to the above embodiments, and is not repeated herein.

In step S12, the main circuit is controlled to perform a global MPPT search based on the regulated voltage.

That is, the process of controlling the main circuit to perform the global MPPT search includes: controlling the main circuit to perform the global MPPT search within a preset range, where an upper limit of the preset range is the open-circuit voltage, and a lower limit of the preset range is an upper limit of a preset oscillation interval in a characteristic curve of the photovoltaic array. The process and principle of the global MPPT search performed within the preset range is referred to the above embodiments, and are not repeated herein.

The power oscillation is suppressed through the steps S11 and S12, thus avoiding the impact on grid-connected power quality. Moreover, in a case that S11 is implemented by performing the pulse blocking or limiting the power, the photovoltaic inverter, without being shut down and restarted, stops the power oscillation and resumes a normal operation with minimal power generation loss.

In addition, as shown in FIG. 11, before step S11, the method for controlling the photovoltaic inverter further includes the following step S100.

In step S100, it is determined whether the power oscillation occurs in the main circuit based on an electrical parameter of the main circuit.

The process of determining the occurrence of the power oscillation includes: detecting whether a low-frequency resonance component exists in at least one of a direct-current voltage, a direct-current current and an alternating-current current in the electrical parameter; determining that the power oscillation occurs in the main circuit, in response to the low-frequency resonance component being detected in the at least one of the direct-current voltage, the direct-current current and the alternating-current current in the electrical parameter. The principle is referred to the above embodiments and is not described herein.

It can be proactively determined that the power oscillation occurs in the photovoltaic inverter through the step S100, thus suppressing the power oscillation through the steps S11 and S12.

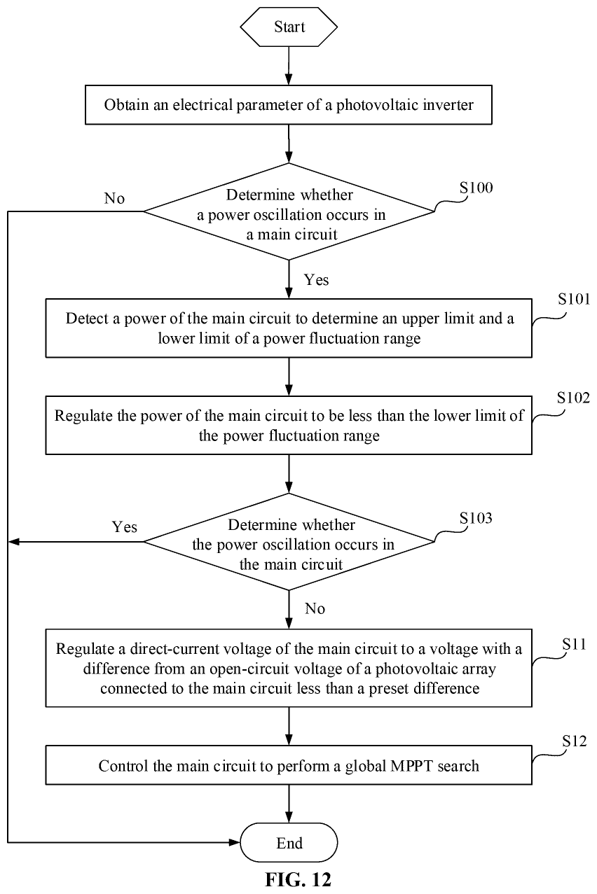

Further, as shown in FIG. 12, after step S100, the method for controlling the photovoltaic inverter further includes the following steps S101 to S103.

In step S101, the power of the main circuit is detected to obtain a power oscillation range, and an upper limit and a lower limit of a power oscillation range are determined.

In step S102, the power of the main circuit is regulated to be less than the lower limit of the power oscillation range.

In step S103, it is determined whether the power oscillation occurs in the main circuit again.

If it is determined that no power oscillation occurs in the main circuit, the step S11 is performed.

It can be proactively determined that the occurrence of the power oscillation in the photovoltaic inverter is caused by the direct-current voltage entering the unstable interval through the steps S101 to S103, and thus suppressing the power oscillation through steps S11 and S12.

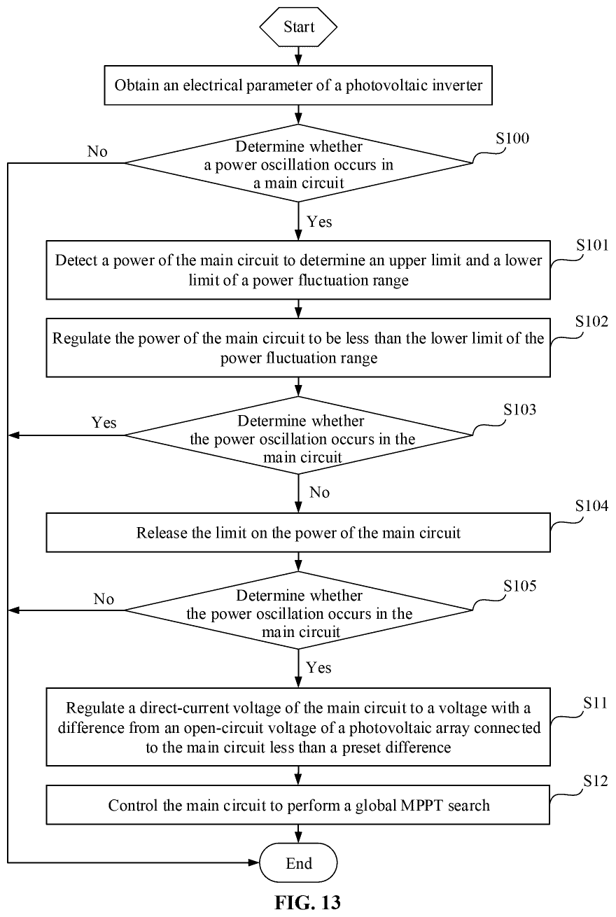

Further, as shown in FIG. 13, after step S103, the method for controlling the photovoltaic inverter further includes the following steps S104 and S105:

In step S104, the limit on the power of the main circuit is released.

In step S105, it is determined whether the power oscillation occurs in the main circuit again.

After S105, if the power oscillation occurs in the main circuit again, the step S11 is performed.

The exclusion of the resonance generated in the control is retested through the steps S104 and S105. If the resonance generated in the control causing the harmonic wave is excluded is excluded, the power oscillation is suppressed through the steps S11 and S12. In practice, the steps S104 and S105 are not necessarily performed, depending on the external environment.

Hereinafter, the method for controlling the photovoltaic inverter is exemplarily described in detail.

During the grid-connected operation of the photovoltaic inverter, the direct-current voltage, the direct-current current, the three-phase grid voltage and the three-phase grid-connected current are sampled in a real time manner, and it is determined that the power oscillation occurs in the photovoltaic inverter to proceed to the next step if a low-frequency resonant component is detected in the three-phase grid-connected current, the direct-current voltage or the direct-current current.

Then, a power outputted by the photovoltaic inverter is detected to determine a fluctuation range of an active power as [P1, P2].

The photovoltaic inverter proactively limits the power of the photovoltaic inverter to P3, where P3<P1, and then detects the direct-current voltage and the three-phase grid-connected current of the photovoltaic inverter. It is determined whether a low-frequency resonant component exists in the direct-current voltage or the three-phase grid-connected current. If the low-frequency resonant component exists in the direct-current voltage or the three-phase grid-connected current, it is determined that the occurrence of the power oscillation is not caused by the direct-current voltage entering the unstable interval. If no low-frequency resonant component exists in the direct-current voltage or the three-phase grid-connected current, and the power outputted by the photovoltaic inverter is P3, it is determined that the occurrence of the power oscillation in the photovoltaic inverter is caused by the direct-current voltage entering the unstable interval, to proceed the next step.

The photovoltaic inverter regulates the direct-current voltage of the photovoltaic inverter to the open circuit voltage Uoc of the photovoltaic array and release the limit on the power of the photovoltaic inverter; and then restarts the global MPPT search, within a search range from 0.8 times of the open circuit voltage Uoc to the open circuit voltage Uoc, finding a direct-current voltage Umpp again corresponding to an actual maximum power point of the current photovoltaic array, so that the direct-current voltage of the photovoltaic inverter is outside the unstable interval.

With the above method according to the embodiments, it can be proactively determined that the occurrence of the power oscillation is caused by the direct-current voltage entering the unstable interval, and then the direct-current voltage is controlled to be outside the unstable interval, thus suppressing the power oscillation.

The same or similar parts among the embodiments in the specification may be referred to each other, and each of the embodiments emphasizes differences from other embodiments. In particular, the system or system embodiment is basically similar to the method embodiment, and therefore is described relatively briefly. For relevant details, reference can be made to the corresponding description of the method embodiment. The system and system embodiments described above are only schematic, in which the units described as separate components may or may not be physically separated, and the components shown as units may or may not be physical units, that is, the components may be located in one place or distributed at multiple network units. Some or all of the units may be selected according to actual requirements to achieve the purpose of the solutions of the embodiments. Those skilled in the art may understand and implement the solution without any creative effort.

Those skilled in the art may further realize that the units and algorithm steps of each example described in conjunction with the embodiments disclosed herein can be implemented by electronic hardware, computer software, or a combination of both. In order to clearly illustrate the interchangeability of hardware and software, the composition and steps of each example have been generally described according to the function in the above description. Whether these functions are performed in hardware or software depends on the specific application and design constraints of the technical solution. Those skilled in the art may implement the described function in various manners for each specific application, however such implementation should not be considered beyond the scope of the present disclosure.

Based on the above description of the disclosed embodiments, the features described in the different embodiments in the specification may be replaced or combined with each other, so that those skilled in the art may implement or use the present disclosure. Various modifications made to the embodiments are apparent to those skilled in the art. The general principle defined herein may be implemented in other embodiments without departing from the spirit and scope of the present disclosure. Therefore, the present disclosure should not be limited to the embodiments disclosed herein, but has the widest scope in accordance to the principles and the novel features disclosed herein.

1. A photovoltaic inverter, comprising:
a main circuit, wherein a direct-current side of the main circuit is configured to connect a photovoltaic array, and an alternating-current side of the main circuit is configured to connect a power grid and/or a load; and
a controller, configured to:
control the main circuit to operate; and
in response to an occurrence of a power oscillation in the main circuit,
regulate a direct-current voltage of the main circuit to a voltage with a difference from an open-circuit voltage of the photovoltaic array less than a preset difference and control the main circuit to perform a global maximum power point tracking (MPPT) search based on the regulated voltage.

2. The photovoltaic inverter according to claim 1, wherein for regulating the direct-current voltage of the main circuit to the voltage with the difference from the open-circuit voltage of the photovoltaic array less than the preset difference, the controller is further configured to:
block a control signal for the main circuit;
limit a power of the main circuit, wherein a difference between a limited power and zero is less than a preset power; or
shut down the photovoltaic inverter.

3. The photovoltaic inverter according to claim 1, wherein for controlling the main circuit to perform the global MPPT search, the controller is further configured to:
control the main circuit to perform the global MPPT search within a preset range.

4. The photovoltaic inverter according to claim 3, wherein
an upper limit of the preset range is the open-circuit voltage, and a lower limit of the preset range is an upper limit of a preset oscillation interval in a characteristic curve of the photovoltaic array.

5. The photovoltaic inverter according to claim 1, further comprising a detection module, wherein
the detection module is configured to detect an electrical parameter of the main circuit and transmit the electrical parameter to the controller, wherein
the controller is further configured to determine whether the power oscillation occurs in the main circuit based on the electrical parameter.

6. The photovoltaic inverter according to claim 5, wherein for determining whether the power oscillation occurs in the main circuit based on the electrical parameter, the controller is further configured to:
detect whether a low-frequency resonant component exists in at least one of a direct-current voltage, a direct-current current and an alternating-current current in the electrical parameter; and
determine that the power oscillation occurs in the main circuit, in response to the low-frequency resonant component being detected in the at least one of the direct-current voltage, the direct-current current and the alternating-current current in the electrical parameter.

7. The photovoltaic inverter according to claim 5, wherein upon determining that the power oscillation occurs in the main circuit, the controller is further configured to:
regulate the power of the main circuit to be less than a lower limit of a power oscillation range; and
determine whether the power oscillation occurs in the main circuit again after regulating the power of the main circuit to be less than the lower limit of the power oscillation range.

8. The photovoltaic inverter according to claim 7, wherein the controller is further configured to:
regulate, upon determining that no power oscillation occurs in the main circuit after regulating the power of the main circuit to be less than the lower limit of the power oscillation range, the direct-current voltage of the main circuit to the voltage with the difference from the open-circuit voltage of the photovoltaic array less than the preset difference; and control the main circuit to perform the global MPPT search based on the regulated voltage.

9. The photovoltaic inverter according to claim 7, wherein the controller is further configured to:
release, upon determining that no power oscillation occurs in the main circuit after regulating the power of the main circuit to be less than the lower limit of the power oscillation range, the limit on the power of the main circuit; and determine whether the power oscillation occurs in the main circuit again after releasing the limit on the power of the main circuit; and
regulate, upon determining that the power oscillation occurs in the main circuit after releasing the limit on the power of the main circuit, the direct-current voltage of the main circuit to the voltage with the difference from the open-circuit voltage of the photovoltaic array less than the preset difference; and control the main circuit to perform the global MPPT search based on the regulated voltage.

10. The photovoltaic inverter according to claim 1, wherein the main circuit comprises:
a direct-current/alternating-current (DC/AC) conversion circuit; or
a DC/AC conversion circuit and at least one direct-current/direct-current (DC/DC) conversion circuit, wherein the at least one DC/DC conversion circuit is connected to a direct-current side of the DC/AC conversion circuit.

11. A method for controlling a photovoltaic inverter, comprising:
in response to an occurrence of a power oscillation in a main circuit of the photovoltaic inverter,
regulating a direct-current voltage of the main circuit to a voltage with a difference from an open-circuit voltage of a photovoltaic array connected to the main circuit less than a preset difference; and
controlling the main circuit to perform a global maximum power point tracking (MPPT) search based on the regulated voltage.

12. The method for controlling the photovoltaic inverter according to claim 11, wherein the regulating a direct-current voltage of the main circuit to a voltage with a difference from an open-circuit voltage of a photovoltaic array connected to the main circuit less than a preset difference comprises one of:
blocking a control signal for the main circuit;
limiting a power of the main circuit, wherein a difference between a limited power and zero is less than a preset power; and
shutting down the photovoltaic inverter.

13. The method for controlling the photovoltaic inverter according to claim 11, wherein the controlling the main circuit to perform an MPPT search comprises:
controlling the main circuit to perform the global MPPT search within a preset range, wherein an upper limit of the preset range is the open-circuit voltage, and a lower limit of the preset range is an upper limit of a preset oscillation interval in a characteristic curve of the photovoltaic array.

14. The method for controlling the photovoltaic inverter according to claim 11, further comprising:
determining whether the power oscillation occurs in the main circuit based on an electrical parameter of the main circuit.

15. The method for controlling the photovoltaic inverter according to claim 14, wherein the determining whether the power oscillation occurs in the main circuit based on an electrical parameter of the main circuit comprises:
detecting whether a low-frequency resonance component exists in at least one of a direct-current voltage, a direct-current current and an alternating-current current in the electrical parameter; and
determining that the power oscillation occurs in the main circuit, in response to the low-frequency resonance component being detected in the at least one of the direct-current voltage, the direct-current current and the alternating-current current in the electrical parameter.

16. The method for controlling the photovoltaic inverter according to claim 14, wherein upon determining that the power oscillation occurs in the main circuit, the method further comprises:
detecting a power of the main circuit to obtain a power oscillation range, and determining an upper limit and a lower limit of the power oscillation range;
regulating the power of the main circuit to be less than the lower limit of the power oscillation range; and
determining whether the power oscillation occurs in the main circuit again after regulating the power of the main circuit to be less than the lower limit of the power oscillation range.

17. The method for controlling the photovoltaic inverter according to claim 16, further comprising:
regulating, upon determining that no power oscillation occurs in the main circuit after regulating the power of the main circuit to be less than the lower limit of the power oscillation range, the direct-current voltage of the main circuit to the voltage with the difference from the open-circuit voltage of the photovoltaic array connected to the main circuit less than the preset difference.

18. The method for controlling the photovoltaic inverter according to claim 16, further comprising:
releasing, upon determining that no power oscillation occurs in the main circuit after regulating the power of the main circuit to be less than the lower limit of the power oscillation range, the limit on the power of the main circuit; and determining whether the power oscillation occurs in the main circuit again after releasing the limit on the power of the main circuit, and
regulating, upon determining that the power oscillation occurs in the main circuit after releasing the limit on the power of the main circuit, the direct-current voltage of the main circuit to the voltage with the difference from the open-circuit voltage of the photovoltaic array connected to the main circuit less than the preset difference.
